(19) United States
(12) Patent Application Publication
(10) Pub. No.: US 2011/0233161 A1
(43) Pub. Date: Sep. 29, 2011

(54) FISHING ROD RETRIEVER

(76) Inventor: Shan A. Gaar, Cape Coral, FL (US)

(21) Appl. No.: 12/732,239

(22) Filed: Mar. 26, 2010

(51) Int. Cl. A47F 7/00; F16M 13/00; A01K 97/10

(52) U.S. Cl. 211/70.8; 248/511; 43/21.2

(57) ABSTRACT

A fishing rod retriever (1) comprising an elongated pole (2), which is preferably telescoping, having a handle (3) on a proximal end (4) and a spiral-shaped wire (6) or a hook-shaped wire (16) on a distal end (7). The spiral-shaped wire and hook shaped wires allow a user to engage and hold the rod portion (8) of a fishing rod (9). At least one substantially L-shaped hook (11) or at least one substantially F-shaped hook (12) is located a predetermined adjustable distance from the distal end of the pole. The fishing rod retriever allows a user to grab and support a fishing rod from a distance, thereby allowing the user to raise or lower the fishing rod out of or into a rod holder (15).

### BACKGROUND OF THE INVENTION

This invention relates to storage accessories for fishing rods, more particularly, a fishing rod retriever used for retrieving fishing rods and storing fishing rods in rod holders mounted to a top of a fishing boat.

Rod holders and rod holder racks are commonly used on boats and other locations for storing fishing rods in a vertical position. Most rod holders are tubular and may have a slit extending halfway down the side of the rod holder for accepting a reel on a fishing rod. The tube may also include a closed bottom for the handle of the fishing rod to rest on. To use a rod holder, the handle of a fishing rod is placed in the rod holder with the base of the rod extending through or to the bottom of the holder. Many fishing boats have rod holders mounted to the top of the boat, to the radar arch or to other overhead structures so that the fishing rods are out of the way. However, fishing rods stored in overhead locations of a boat are difficult to reach while standing in the boat. Therefore, a user must stand on something, such as an object in the boat or the gunwales of the boat and/or climb up onto the top of the boat to retrieve fishing rods stored in overhead locations. This can be difficult and dangerous, especially while the boat is out at sea.

Therefore, a need exists for a device that will allow a user to retrieve a fishing rod from a rod holder mounted in an overhead location of a boat and to place a fishing rod in a rod holder mounted in an overhead location of a boat while the user is standing safely in the boat.

The relevant prior art includes the following references:

| Patent No. | | |
|---|---|---|
| (U.S. unless stated | | |
| otherwise) | Inventor | Issue/Publication Date |
| CN2,829,368 | Cui | Oct. 25, 2006 |
| 6,701,578 | Lu | Mar. 09, 2004 |
| 6,652,013 | Peterson | Nov. 25, 2003 |
| 5,946,844 | Stoliar et al. | Sep. 07, 1999 |
| GB2,329,818 | Baker | Jul. 04, 1999 |
| 5,799,602 | Trillo | Sep. 01, 1998 |
| 5,699,748 | Linskey, Jr. et al. | Dec. 23, 1997 |
| 5,586,515 | Nickles | Dec. 24, 1996 |
| 5,472,251 | Deininger | Dec. 05, 1995 |
| 5,381,749 | Larson | Jan. 17, 1995 |
| 5,365,688 | Yong-Set | Nov. 22, 1994 |
| 5,054,228 | Elkins | Oct. 08, 1991 |
| 5,003,907 | Roach et al. | Apr. 02, 1991 |
| 4,986,207 | Reed | Jan. 22, 1991 |
| 4,848,020 | Lash | Jul. 18, 1989 |
| 4,596,405 | Jones | Jun. 24, 1986 |
| 4,508,467 | Choffin | Apr. 02, 1985 |
| 4,121,531 | Norton | Oct. 24, 1978 |
| 4,004,539 | Wesson | Jan. 25, 1977 |
| 3,993,013 | Nunziato et al. | Nov. 23, 1976 |
| 3,799,099 | Conover | Mar. 26, 1974 |
| 3,467,116 | Ringewaldt | Sep. 16, 1969 |
| 3,442,544 | Faber | May 06, 1969 |
| 2,784,516 | Barnes et al. | Mar. 12, 1957 |
| 2,549,257 | Staunt | Apr. 17, 1951 |

### SUMMARY OF THE INVENTION

The primary object of the present invention is to provide a fishing rod retriever that allows a user to safely remove a fishing rod from a rod holder mounted in an overhead location of a boat while standing in the boat.

Another object of the present invention is to provide a user to safely place a fishing rod into a rod holder mounted in an overhead location of a boat while standing in the boat.

An even further object of the present invention is to provide a fishing rod retriever that allows a user to safely remove a fishing rod from a rod holder mounted in an overhead location other than in a boat.

Another object of the present invention is to provide a fishing rod retriever that allows a user to safely place a fishing rod into a rod holder mounted in an overhead location other than in a boat.

An even further object of the present invention is to provide a fishing rod retriever that will engage a fishing rod even if there is not a reel attached to the fishing rod.

The present invention fulfills the above and other objects by providing a fishing rod retriever comprising an elongated pole, which is preferably telescoping, having a handle on a proximal end and a rod holding means, such as a spiral-shaped wire, hook-shaped wire, etc., on a distal end. The rod holding means allows a user to grab and support the rod portion of a fishing rod from a distance. For example, the spiral-shaped wire allows a user to engage and hold the rod portion of a fishing rod by spinning the wire around the rod. A reel holding means, such as at least one substantially L-shaped hook, at least one substantially F-shaped hook, etc., is located on the telescoping pole between the proximal and distal ends. The telescoping bar enables the user to adjust the distance between the reel holding means and the rod holding means to accommodate various sizes of fishing rods and to collapse the fishing rod retriever when not in use for easy storage. The reel holding means allows a user to grab and support the reel portion of a fishing rod from a distance. For example, the substantially L-shaped hook may be placed under a cross bar on the reel portion of the fishing rod or under the base of the reel portion, thereby allowing the user to raise or lower the fishing rod out of or into a rod holder. Alternatively, the substantially F-shaped hook may be placed around the base of the reel portion of the fishing rod, thereby allowing the user to raise or lower the fishing rod out of or into a rod holder. The rod holding means and reel holding means may be integral to a pole or have attachment means for retrofitting an existing line pole to be a fishing rod retriever.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a fishing rod retriever of the present invention;

FIG. 2 is a side view of a fishing rod retriever of the present invention engaged with a fishing rod being stored in a rod holder; and

FIG. 3 is a side view of a fishing rod retriever of the present invention having a hook-shaped wire and L-shaped hooks.

### DESCRIPTION OF THE PREFERRED EMBODIMENTS

For purposes of describing the preferred embodiment, the terminology used in reference to the numbered accessories in the drawings is as follows:

| | |
|---|---|
| 1. | fishing rod retriever |
| 2. | telescoping pole |
| 3. | handle |
| 4. | proximal end |
| 5. | rod holding means |
| 6. | spiral-shaped wire |
| 7. | distal end |
| 8. | rod portion |
| 9. | fishing rod |
| 10. | reel holding means |
| 11. | L-shaped hook |
| 12. | F-shaped hook |
| 13. | reel portion |
| 14. | attachment means |
| 15. | rod holder |
| 16. | hook shaped wire |
| 17. | pivot point |
| 18. | reel seat |

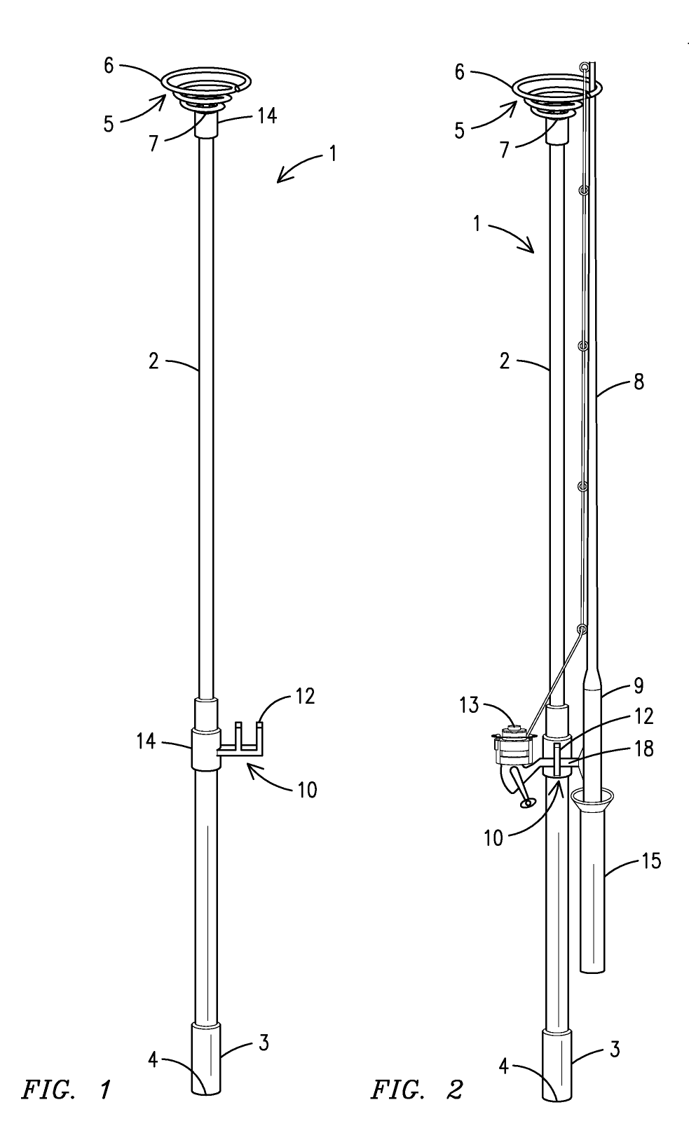

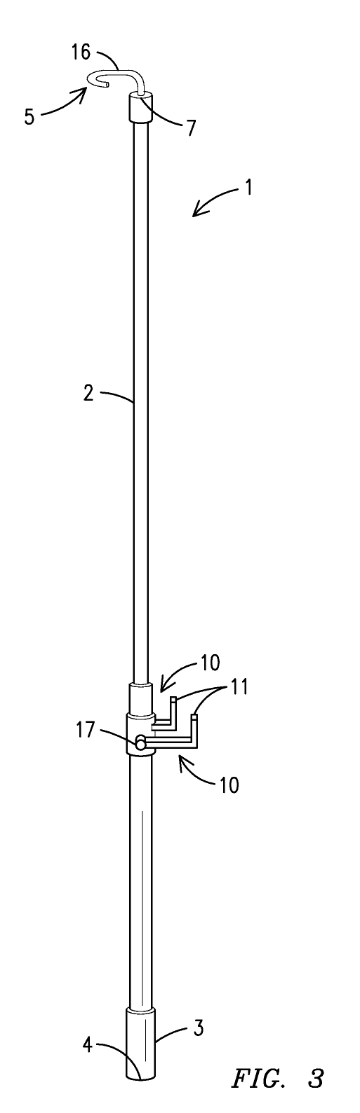

With reference to FIG. 1, a side view of a fishing rod retriever 1 of the present invention is shown. The fishing rod retriever 1 comprises a telescoping pole 2 having a handle 3 on a proximal end 4 and a rod holding means 5, such as a substantially spiral-shaped wire 6 (or a hook-shaped wire 16 as shown in FIG. 3) on a distal end 7. The rod holding means 5 allows a user to grab and support the rod portion 8 of a fishing rod 9 from a distance, as shown further in FIG. 2. A reel holding means 10, such as at least one substantially L-shaped hook 11 (as shown in FIG. 3), at least one substantially F-shaped hook 12, etc., is located on the telescoping pole 2 between the proximal end 4 and distal end 7. The telescoping pole 2 enables the user to adjust the distance between the rod holding means 5 and the reel holding means 10 to accommodate various sizes of fishing rods 9 and to be collapsed when not in use for easy storage. The reel holding means 10 allows a user to engage and support the reel portion 13 or reel seat 18 of a fishing rod 9 from a distance, as shown further in FIG. 2. The rod holding means 5 and reel holding means 10 may be integral parts of the telescoping pole 2 or removably attachable to an existing boat hook pole via an attachment means 14 thereby retrofitting an existing line hook to be a fishing rod retriever 1. For example, the attachment means 14 for attaching the rod holding means 5 to an existing boat hook pole may be a threaded connection, a compression fit, snap-on connection, welding, etc. and the attachment means 14 for attaching the reel holding means 10 may be a hose clamp, a pipe clamp, etc.

With reference to FIG. 2, a side view of a fishing rod retriever 1 of the present invention engaged with a fishing rod 9 stored in a rod holder 15 is shown. A rod holding means 5, such as a spiral-shaped wire 6, hook-shaped wire, etc., located on a distal end 7 of a telescoping pole 2 allows a user to grab and support the rod portion 8 of a fishing rod 9 from a distance. As illustrated here, the spiral-shaped wire 6 allows a user to engage and hold the rod portion 8 of the fishing rod 9 by spinning the spiral-shaped wire 6 around the rod portion 8. A reel holding means 10, such as at least one substantially L-shaped hook 11, at least one substantially F-shaped hook 12, etc., is located on the telescoping pole 2 between the proximal end 4 and distal end 7. The telescoping pole 2 enables the user to adjust the distance between the rod holding means 5 and the reel holding means 10 to accommodate various sizes of fishing rods 9 and to be collapsed when not in use for easy storage. As illustrated here, the reel holding means 10 may be placed around the base 16 of the reel portion 13, thereby allowing the user to raise or lower the fishing rod 9 out of or into a rod holder 15.

Finally, with reference to FIG. 3, a side view of a fishing rod retriever 1 of an embodiment of the present invention having a hook-shaped wire 16 and L-shaped hooks 11 is shown. The fishing rod retriever 1 comprises a telescoping pole 2 having a handle 3 on a proximal end 4 and a rod holding means 5, which as shown here is a hook-shaped wire 16, on a distal end 7. A reel holding means 10, which as shown here is as at least one substantially L-shaped hook 11, is located a predetermined adjustable distance from the rod holding means 5 on the telescoping pole 1. The at least one substantially L-shaped hook 11 is attached to the telescoping pole 2 via at least one pivot point 17 that allows a user to fold the at least one substantially L-shaped hook 11 out of the way when not in use.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A fishing rod retriever comprising:
a rod holding means that is removably attachable to a pole via an attachment means; and
a reel holding means that is removably attachable to a pole via an attachment means.

2. The fishing rod retriever of claim 1 wherein:
said rod holding means is a substantially spiral-shaped wire.

3. The fishing rod retriever of claim 1 wherein:
said rod holding means is a substantially hook-shaped wire.

4. The fishing rod retriever of claim 1 wherein:
said reel holding means is at least one substantially F-shaped hook.

5. The fishing rod retriever of claim 1 wherein:
said reel holding means is at least one substantially L-shaped hook.

6. The fishing rod retriever of claim 1 wherein:
said attachment means is a compression fit.

7. The fishing rod retriever of claim 1 wherein:
said attachment means is a threaded connection.

8. The fishing rod retriever of claim 1 wherein:
said attachment means is a snap-on connection.

9. The fishing rod retriever of claim 1 wherein:
said attachment means is a hose clamp.

10. The fishing rod retriever of claim 1 wherein:
said attachment means is a pipe clamp.

11. A fishing rod retriever comprising:
a pole having a distal end and a proximal end;
a rod holding means located on the distal end of the pole; and
a reel holding means that is located on the pole at a predetermined distance between the proximal end and distal end.

12. The fishing rod retriever of claim 11 wherein:
said rod holding means is a substantially spiral-shaped wire.

13. The fishing rod retriever of claim 11 wherein:
said rod holding means is a substantially hook-shaped wire.

14. The fishing rod retriever of claim 11 wherein:
said reel holding means is at least one substantially F-shaped hook.

15. The fishing rod retriever of claim 11 wherein:
said reel holding means is at least one substantially L-shaped hook.

16. The fishing rod retriever of claim 11 wherein:
said pole is a telescoping pole.

17. The fishing rod retriever of claim 11 wherein:
said reel holding means is pivotally attached to the pole.

18. A fishing rod retriever comprising:
a pole having a distal end and a proximal end;
a spiral shaped wire located on the distal end of the pole; and
a reel holding means that is located on the pole at a predetermined distance between the proximal end and distal end.

19. The fishing rod retriever of claim 18 wherein:
said reel holding means is at least one substantially F-shaped hook.

20. The fishing rod retriever of claim 18 wherein:
said reel holding means is at least one substantially L-shaped hook.

21. The fishing rod retriever of claim 18 wherein:
said pole is a telescoping pole.

22. The fishing rod retriever of claim 18 wherein:
said reel holding means is pivotally attached to the pole.
